(19) United States
(12) Patent Application Publication
(10) Pub. No.: US 2009/0064317 A1
(43) Pub. Date: Mar. 5, 2009

(54) DATA PROTECTION SYSTEM AND METHOD THEREOF

(75) Inventor: QI-DA GUAN, Foshan (CN)

Correspondence Address: PCE INDUSTRY, INC.;ATT. CHENG-JU CHIANG, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 11/967,102

(22) Filed: Dec. 29, 2007

(30) Foreign Application Priority Data
Aug. 30, 2007 (CN) 200710201523.2

(51) Int. Cl. G06F 21/00

(52) U.S. Cl. 726/18

(57) ABSTRACT

An exemplary data protection system includes a storage module, an input module, and a logistic module. The storage module is configured for storing data and a preset password. The input module is configured for inputting a password. The logistic module is configured for comparing the input password with the preset password. If the input password is identical to the preset password, the data stored in the storage module is set to accessible. When operations of accessing to data are finished, the data is blocked from accessing.

### TECHNICAL FIELD

The present invention relates to a data protection systems and methods thereof, and specifically, to an image protection system and method of a digital product.

### BACKGROUND

With ongoing developments in digital science technology, new digital products such as digital cameras and mobile phones with camera function have become popular in daily life. Pictures can be stored by the digital products and transmitted over hardwired/wireless networks. However, regarding transmitting image files of these pictures, it is important to ensure that data (like image files) is safely kept and access to it suitably controlled. Therefore, a data protection method can help to ensure data privacy and data protection.

A conventional data protection method for image files is introduced. The protection method separates an image file into a first part and a second part. The protection method encrypts the second part and replaces the first part with substitute data to protect the data. To access the data, the protection system has to find the second part first, decipher the second part first, and then restore the first part after the second part is deciphered. Generally, the conventional protection method involves complex processes and therefore consumes time and memory of computers.

Therefore, it is desired to provide a simple and faster data protection method and system.

### SUMMARY

In accordance with a present embodiment, a data protection system is provided. The data protection system includes a storage module, an input module, and a logistic module. The storage module is configured for storing data and a preset password. The input module is configured for inputting a password. The logistic module is configured for comparing the input password with the preset password. If the input password is not identical to the preset password, the storage module is blocked from accessing data.

Other novel features and advantages will be drawn from the following detailed description of at least one preferred embodiment, when considered in conjunction with the attached drawings.

### BRIEF DESCRIPTION OF THE DRAWINGS

Many aspects of the present data protection system and method can be better understood with reference to the following drawings. The components in the drawings are not necessarily drawn to scale, the emphasis instead being placed upon clearly illustrating the principles of the present data protection system and method. Moreover, in the drawings, like reference numerals designate corresponding parts throughout the several views.

FIG. 1 is a schematic diagram of a data protection system in a present embodiment of this invention.

FIG. 2 is a schematic diagram of the storage module of FIG. 1.

FIG. 3 is a flow chart of determining a preset password in the present embodiment of this invention.

FIG. 4 is a flow chart of a data protection method of FIG. 1.

### DETAILED DESCRIPTION OF THE PREFERRED EMBODIMENTS

Embodiments of the present data protection system and method will now be described in detail below and with reference to the drawings.

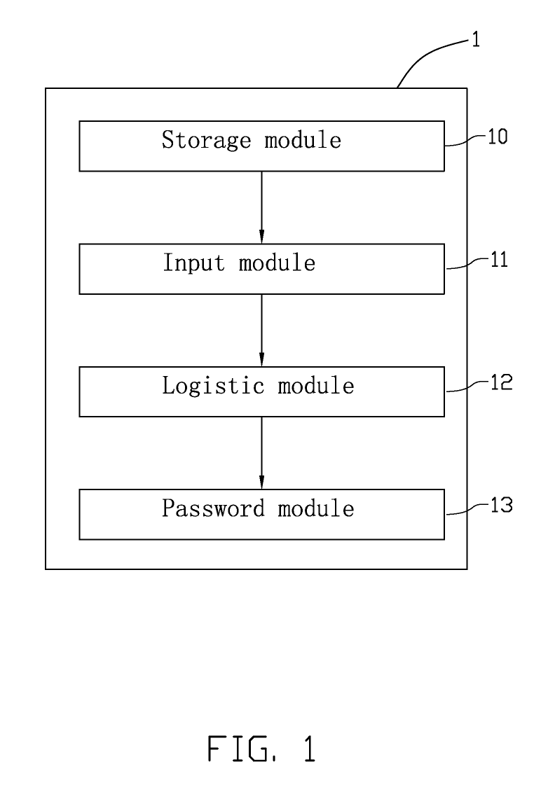

Referring to FIG. 1, a schematic diagram of a data protection system 1 in accordance with a present embodiment is shown. The data protection system 1 is configured for being incorporated in a digital product (not shown). The digital product can be, for example, a digital camera. The data protection system 1 includes a storage module 10, an input module 11, and a logistic module 12, and a password module 13.

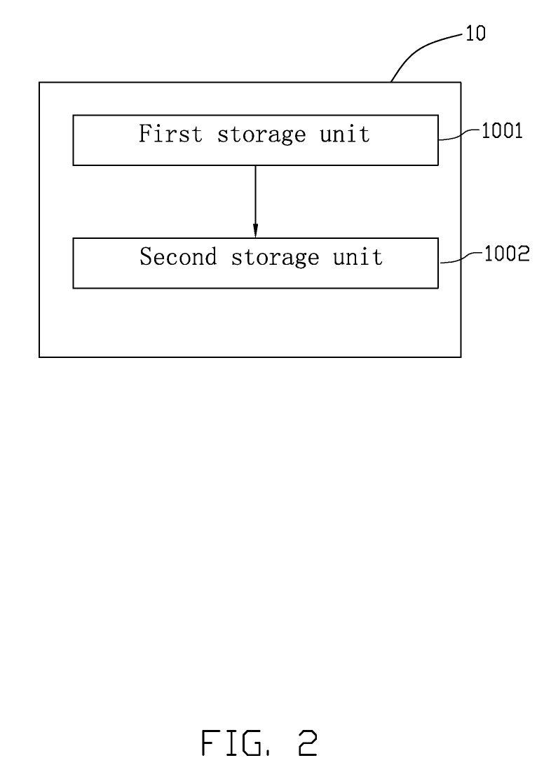

The storage module 10 is configured for storing data (for example, image files taken by the digital camera), a preset password, and a flag setting. In this present embodiment, the storage module 10 includes at least, as shown in FIG. 2, a first storage unit 1001, and a second storage unit 1002. The first storage unit 1001 is configured for storing the data. The second storage unit 1002 is configured for storing the flag setting and the preset password.

The flag setting can be a first value or a second value. When the flag setting is the first value, access to the first storage unit 1001 is blocked. When the flag setting is the second value, the first storage unit 1001 is accessible.

The preset password is a predetermined password of the data protection system 1. The preset password is configured for ensuring privacy and protecting the first storage unit 1001 of the storage module 10 from unauthorized access.

The input module 11 is configured for inputting a password. When the input password is identical to the preset password, the data stored in the first storage unit 1001 of the storage module 10 becomes accessible.

The logistic module 12 is configured for comparing the input password with the preset password. If the input password is identical to the preset password, then the flag setting is changed to the second value and the data stored in the first storage unit 1001 is capable of being accessed. After operations of accessing the data stored in the first storage unit 1001 are finished, the flag setting is changed to the first value. If the input password is not identical to the preset password, then the flag setting is set to the first value and the first storage unit 1001 is blocked.

Operations of accessing the data stored in the first storage unit 1001 include, for example, opening, copying, printing, and transferring, and editing operations.

The password module 13 is configured for determining the preset password, which is stored in the second storage unit 1002.

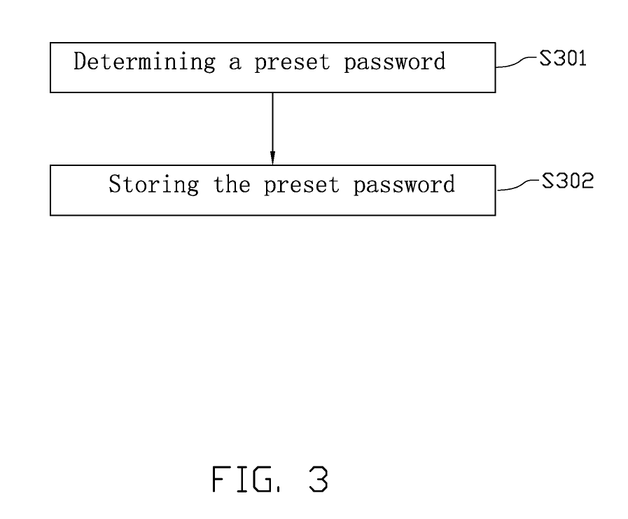

Referring to FIG. 3, a flow chart of determining the preset password in accordance with the present embodiment is shown. The flow includes:
STEP 301: determining a preset password; and
STEP 302: storing the preset password.

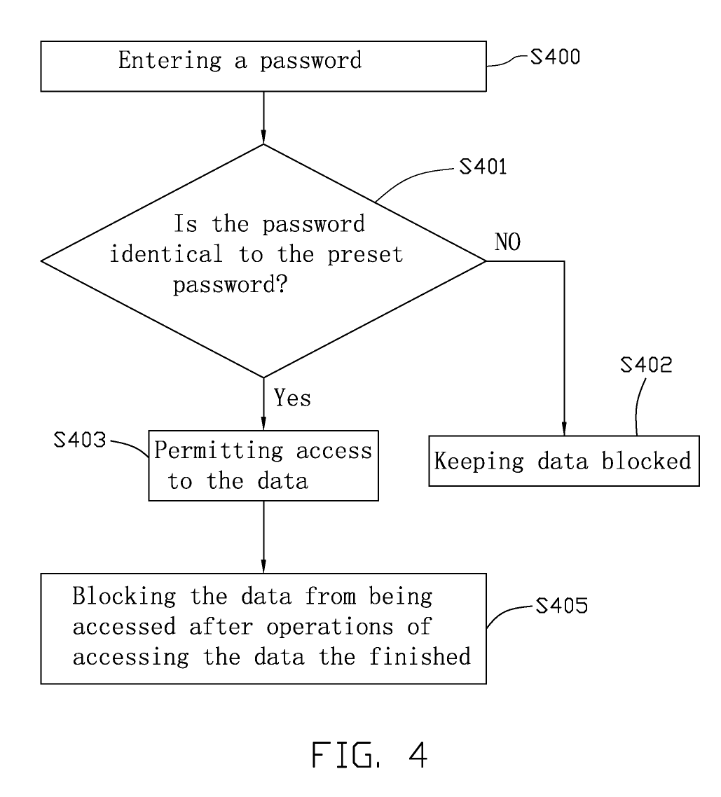

Referring to FIG. 4, a data protection method in accordance with the present embodiment is shown. The data protection method includes:
STEP 400: inputting a password;
STEP 401: comparing the input password with the preset password. If the input password is identical to the preset password, then go to step 403; if the input password is not identical to the preset password, then go to step 402;
STEP 402: keeping the data blocked;
STEP 403: set the data stored in the storage module 10 to be accessible; and
STEP 405: blocking the data stored in the storage module 10 from being accessed after operations of accessing the data are finished.

It will be understood that the above particular embodiments are described and shown in the drawings by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A data protection system comprising:
a storage module configured for storing data and a preset password;
an input module configured for inputting a password; and
a logistic module configured for comparing the input password with the preset password;
wherein if the input password is not identical to the preset password, access to the data stored in the storage module is blocked.

2. The data protection system as claimed in claim 1, wherein the storage module comprises a first storage unit configured for storing the data.

3. The data protection system as claimed in claim 1, wherein the storage module comprises a second storage unit configured for storing the preset password.

4. The data protection system as claimed in claim 3, wherein the second storage unit stores a flag setting having one value of a first value and a second value.

5. The data protection system as claimed in claim 4, wherein if the flag setting is the first value, access to the data is blocked.

6. The data protection system as claimed in claim 4, wherein if the flag setting is the second value, the data is accessible.

7. The data protection system as claimed in claim 5, wherein if the input password is not identical to the preset password, the flag setting is set to the first value.

8. The data protection system as claimed in claim 1, further comprising a password module configured for determining the preset password.

9. A data protection method of a digital product having a stored data, comprising:
determining a preset password;
inputting a password;
comparing the input password with the preset password, if the input password being identical to the preset password then set the stored data to be accessible; and
blocking the stored data from being accessed after operations of accessing the stored data are finished.

10. The data protection method as claimed in claim 9, wherein if the input password is not identical to the preset password, then blocking the stored data from being accessed.
